(19) United States
(12) Patent Application Publication
(10) Pub. No.: US 2016/0336789 A1
(43) Pub. Date: Nov. 17, 2016

(54) WIRELESS CHARGING DEVICE FOR VEHICLE

(71) Applicant: Samsung Electro-Mechanics Co., Ltd., Suwon-si (KR)

(72) Inventors: Ji Ho HYUN, Suwon-si (KR); Young Jun JO, Suwon-si (KR)

(73) Assignee: Samsung Electro-Mechanics Co., Ltd., Suwon-si (KR)

(21) Appl. No.: 15/151,900

(22) Filed: May 11, 2016

(30) Foreign Application Priority Data
May 15, 2015 (KR) 10-2015-0068305
Oct. 1, 2015 (KR) 10-2015-0138726

(51) Int. Cl. H02J 7/02; H01F 38/14; H02J 7/00; H02J 50/12

(52) U.S. Cl. CPC H02J 7/025; H02J 50/12; H01F 38/14; H02J 7/0042

(57) ABSTRACT

A wireless charging device for a vehicle includes an external cover configured to be pivotally connected to an interior of a vehicle and including a wireless charger within the external cover; an internal cover movably connected to an inner surface of the external cover and configured to elastically support a power receiving device receiving electrical power transmitted by the wireless charging module; and at least one elastic joint elastically connecting the internal cover to the external cover.

### CROSS-REFERENCE TO RELATED APPLICATION

This application claims the benefits of Korean Patent Application No. 10-2015-0068305 filed on May 15, 2015, and 10-2015-0138726 filed on Oct. 1, 2015 in the Korean Intellectual Property Office, the entire disclosure of which is incorporated herein by reference for all purposes.

### BACKGROUND

1. Field

The following description relates to a wireless charging device for a vehicle, in which a portable terminal may be stably mounted.

### 2. Description of Related Art

In general, wireless telecommunications devices need to be charged with electrical power, and in this regard, recently developed portable devices have different types of wired charging connectors.

In order to charge a battery pack of a portable terminal with electrical power, there exists a charging method using connection of a terminal in which commercially-available power is received by a power supply device, voltages and currents thereof are converted to correspond to those required to charge a battery pack of a portable terminal, and the converted electrical power is supplied to the battery pack through a terminal of the battery pack. Alternatively, a wireless charging method, which was developed to reduce the inconvenience of a wired charging method, exists using the terminal connection.

Two main methods exist in the field of wireless charging technology: namely (1) a magnetic resonance wireless charging method and (2) a magnetic induction wireless charging method. Between these two wireless charging methods, the magnetic induction wireless charging method has been predominately applied such that wireless charging technology has witnessed a rapid growth in popularity.

However, in the case of a wireless charging device mounted in a vehicle, a problem in which impacts or vibrations occurring during driving cause a portable terminal to be detached from a holder or disturb the electrical coupling with the charger may tend to occur. Therefore, there is demand for a device in which a portable terminal device may be more stably mounted while being wirelessly charged in a vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a general aspect, a wireless charging device for a vehicle, includes an external cover configured to be pivotally connected to an interior of a vehicle and including a wireless charger within the external cover; an internal cover movably connected to an inner surface of the external cover and configured to elastically support a power receiving device receiving electrical power transmitted by the wireless charging module; and at least one elastic joint elastically connecting the internal cover to the external cover.

The elastic joint may be formed of a coil spring, one end of the elastic joint may be connected to the external cover, and the other end of the elastic joint may be connected to the internal cover.

The internal cover may be provided with at least one cut-out portion formed adjacently to an entrance into which the power receiving device is inserted.

The external cover may include a pair of side portions protruding from edges of a surface of the external cover toward the internal cover.

The side portions of the external cover may be disposed perpendicular to a pivot axis of the external cover.

The internal cover may include a pair of side portions protruding toward the external cover.

The internal cover may be in surface contact with the power receiving device and is configured to elastically support the power receiving device.

The wireless charging device for a vehicle may further include a magnetic portion attached to an inner surface of the internal cover.

The magnetic portion may be configured of a ferrite sheet.

The wireless charger may include a coil portion including at least one coil, and a circuit portion electrically connected to the coil portion to control electrical power applied to the coil portion.

The coil portion and the circuit portion may be provided in a form of a planar plate, and embedded in the external cover in an overlapping state.

According to another general aspect, a wireless charging device for a vehicle includes an external cover configured to open or close an entrance of a storage space; an internal cover elastically connected to the external cover and configured to elastically support a power receiving device to maintain the power receiving device in surface contact with a surface of the external cover; and a wireless charger disposed within the external cover and configured to wirelessly transmit electrical power to the power receiving device.

Other features and aspects will be apparent from the following detailed description, the drawings, and the claims.

### BRIEF DESCRIPTION OF DRAWINGS

FIG. 1A is a schematic perspective view of a wireless charging device for a vehicle according to an embodiment.

FIG. 1B is a perspective view of a state in which a cover of the wireless charging device for a vehicle illustrated in FIG. 1A is closed.

FIG. 2 is a schematic perspective view of the cover of the wireless charging device for a vehicle illustrated in FIG. 1A.

FIG. 3 is a cross-sectional view taken along line A-A of FIG. 2.

FIGS. 4A and 4B are side views of the cover illustrated in FIG. 2.

FIG. 5 is a schematic perspective view of a wireless charger according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there are no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” than the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the following description is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views. In the drawings, for example, due to manufacturing techniques and/or tolerances, modifications of the shape shown may be encountered. Thus, embodiments should not be construed as being limited to the particular shapes of regions shown herein, but should be understood to include, for example, a change in shape resulting from manufacturing. The following embodiments may also be constituted by one or a combination thereof.

In addition, in describing embodiments below, examples of a power receiving device may include various portable terminals such as a smartphone, a mobile phone, a personal digital assistant (PDA), an MP3 player, a tablet PC, a portable multimedia player (PMP), and the like.

In addition, in an embodiment, a wireless charging device for a vehicle is illustrated as being disposed in a lower portion of a dashboard, center console, or armrest of a vehicle, but is not limited thereto. A cup holder device may also be disposed in various positions such as in a center console, in an armrest, a seat, a door, wall-portion, ceiling-portion, or the like.

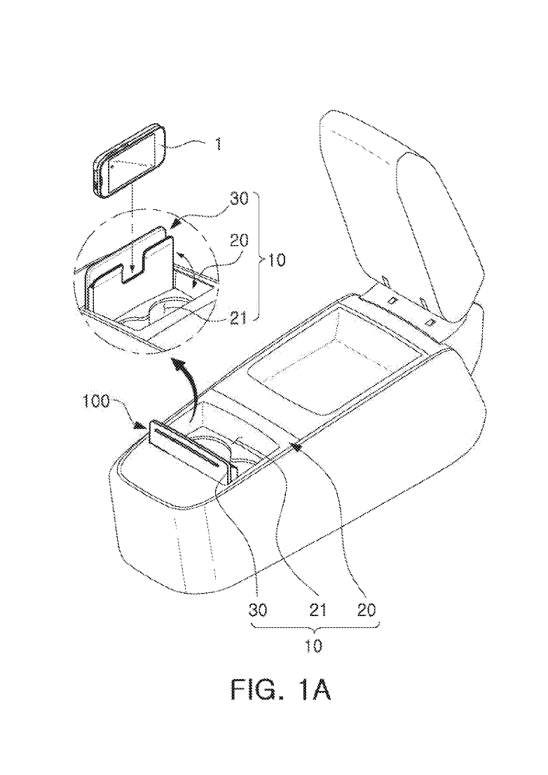

FIG. 1A is a schematic view of a wireless charging device for a vehicle according to an embodiment and a perspective view of a state in which a cover is open. FIG. 1B is a perspective view of a state in which the cover of the wireless charging device for a vehicle illustrated in FIG. 1A is closed.

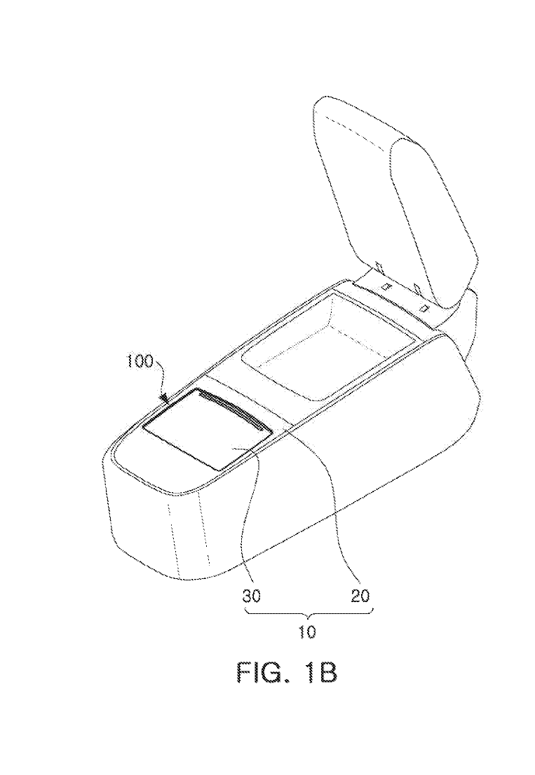

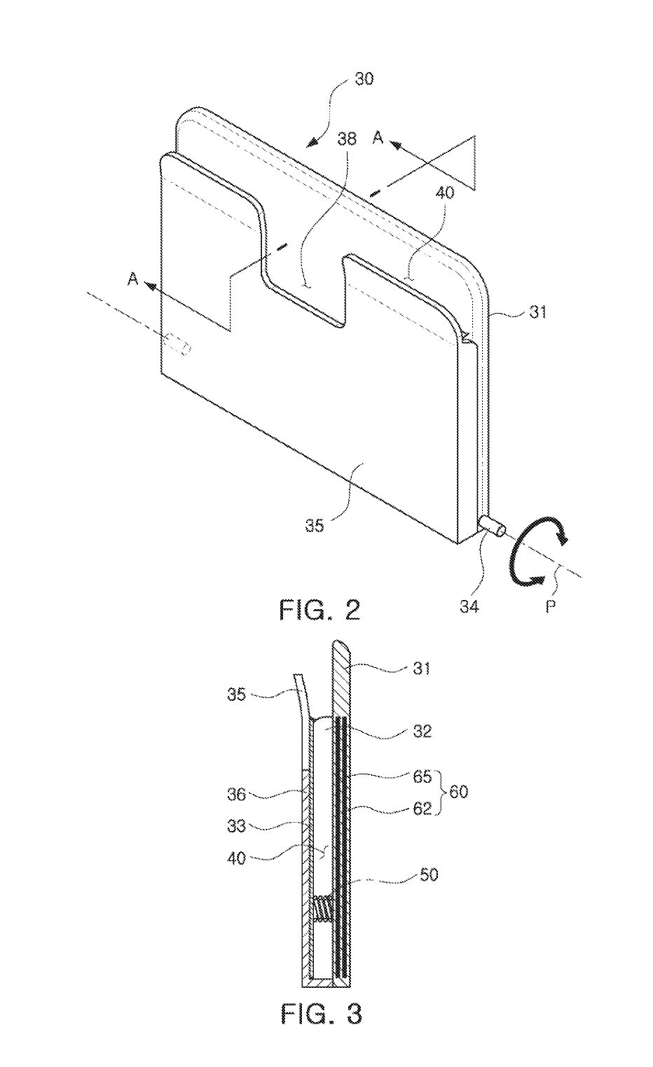

FIG. 2 is a schematic perspective view of the cover of the wireless charging device for a vehicle illustrated in FIG. 1A, and FIG. 3 is a cross-sectional view of the cover illustrated in FIG. 2.

With reference to FIGS. 1A to 3, a wireless charging device for a vehicle 100 according to the embodiment is configured, for example, as a portion of a storage receptacle 10.

The storage receptacle 10 may be mounted in an internal structure of a vehicle. In this case, the internal structure of a vehicle may be various structures such as a dashboard, a center console, an armrest of a vehicle, and the like.

The storage receptacle 10 may include a storage space 21 in which an article may be stored. For example, the storage receptacle 10 according to the embodiment may be a cup holder for holding a cup.

The storage receptacle 10 according to the embodiment includes a storage portion 20 and a cover 30, and the wireless charging device for a vehicle 100 according to the embodiment may be integrally formed in the cover 30 of the storage receptacle 10. Thus, the cover 30 of the storage receptacle 10, itself, may house the wireless charging device for a vehicle 100.

The cover 30 is connected with one side of the storage portion 20 adjacently to an entrance of the storage space 21. The cover 30 may be connected with the storage portion 20 in such a manner that the cover may open or close the entrance of the storage space 21. For example, the cover 30 may be pivotally connected to the storage portion 20 by a pin joint. In this case, the cover 30 pivots on a pin (34 in FIG. 2) as a pivot axis (P in FIG. 2), and may open or close the entrance of the storage space 21.

The cover 30 may be configured to be able to be opened or closed through manual operations, but is not limited thereto. The cover 30 may also be configured to be automatically opened or closed by using a driving unit such as a motor, or the like.

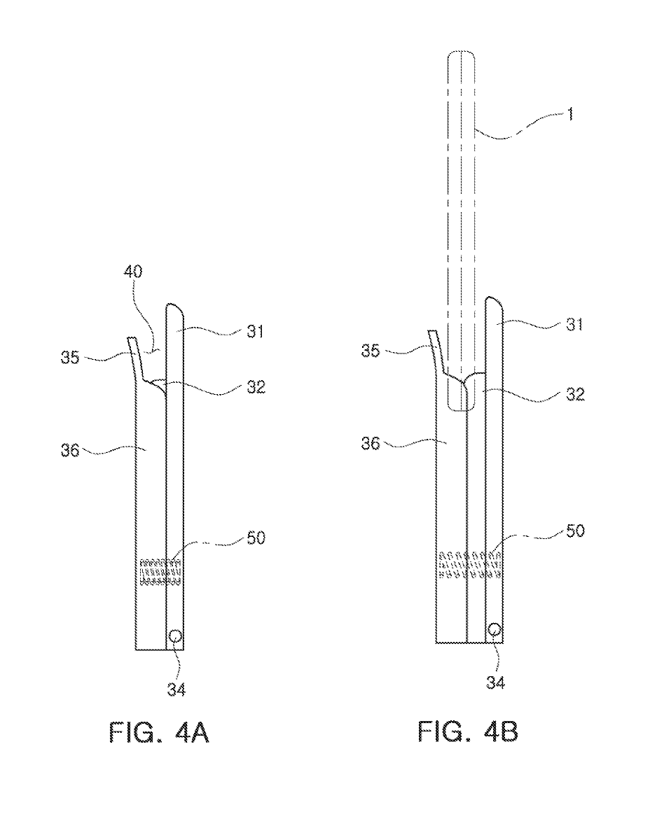

FIGS. 4A and 4B are side views of the cover illustrated in FIG. 2. In detail, FIG. 4A illustrates a state in which a portable terminal 1 is not inserted, while FIG. 4B illustrates a state in which the portable terminal 1 is inserted.

With reference to FIGS. 4A and 4B, the cover 30 according to the embodiment includes an external cover 31 and an internal cover 35.

The external cover 31 is a portion of the cover 30, which is a portion outwardly exposed when the cover 30 closes the storage portion 20. For example, the external cover 31 is a plate disposed on an outermost side of the cover 30.

On edges of a surface of the external cover 31, a pair of side portions 32 protruding toward the internal cover 35 are formed.

The side portions 32 of the external cover 31 are disposed substantially perpendicular to the pivot axis P of the external cover 31 on edges of the external cover 31. Thus, the portable terminal is inserted into an insertion space 40 through the entrance formed in an upper portion of the wireless charging device for a vehicle 100 in a state in which the external cover 31 is opened (See FIG. 2).

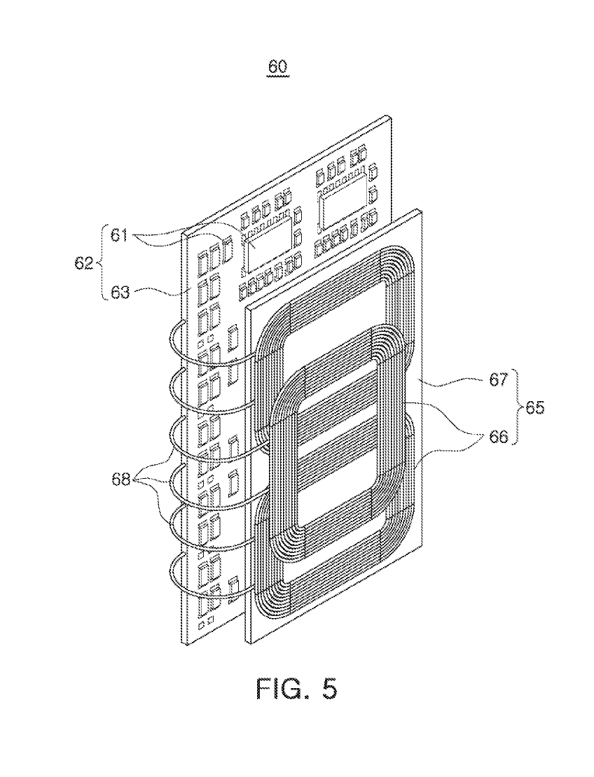

The external cover 31 includes a wireless charger (60 in FIG. 5) therein. The wireless charger 60 charges a battery of the portable terminal 1 by wirelessly transmitting electrical power thereto.

The wireless charger 60 is embedded in the external cover 31. For example, the wireless charger 60 may be completely embedded in the external cover 31 so as not to be visible to the naked eye from the outside thereof. However, a configuration of the wireless charger 60 is not limited thereto, and the wireless charger 60 may be configured to be partially exposed if necessary.

FIG. 5 is a schematic perspective view of the wireless charger according to an embodiment. With reference to FIG. 5, the wireless charger 60 includes a coil structure 65 including at least one coil 66, and a charger circuit 62 supplying an electrical current to the coil structure 65.

The coil structure 65 may form a magnetic field under the control of the charger circuit 62 and emit electrical power wirelessly. To this end, in the case of the coil structure 65, one or more coils 66 are mounted on a substrate 67. In this case, the coil 66 is established in wire form, but is not limited thereto. The coil 66 may be variously formed. For example, the coil 66 may be formed by forming a conductive pattern on the substrate, or formed using a coil formed of a substantially rectangular copper wire.

The charger circuit 62 includes a plurality of electronic components 61 mounted on a circuit board 63, and may also include a circuit controlling charging. Thus, the coil structure 65 emits electrical power under the control of the charger circuit 62, and transmits electrical power to the portable terminal.

The charger circuit 62 may be electrically connected to the coil structure 65 by a connector 68. In this case, the connector 68 may be formed of a conductive wire in wire form or formed as a flexible substrate.

In the case of the wireless charger 60 according to the embodiment, the charger circuit 62 and the coil structure 65 may be formed as thin plates, respectively, and may overlap each other to be embedded in the external cover 31 in an overlapping state, as illustrated in FIG. 3. In this case, the wireless charger 60 may be embedded in the external cover 31 in such a manner that the coil 66 of the coil structure 65 may be disposed on an inner surface of the external cover 31, toward the insertion space 40.

Thus, an overall area of the wireless charger 60 may correspond to an area of the charger circuit 62 or the coil structure 65, while a thickness of the wireless charger 60 may correspond to an overall thickness of the charger circuit 62 and the coil structure 65.

Since the charger circuit 62 and the coil structure 65 are embedded in the external cover 31 in an overlapping state, the wireless charger 60 may be disposed within the external cover 31 without an area of a cover of a cup holder of the related art being increased in size.

In the meantime, the thickness of the wireless charger 60 may lead to an increase in a thickness of the external cover 31. However, the thickness of the external cover 31 may be reduced by reducing the thickness of the wireless charger 60, for example, by forming the coil structure 65 and/or charger circuit 62 as one or more thin-film coils.

The internal cover 35 is disposed on an inner side of the external cover 31, within the storage space 21 in a case in which the cover 30 covers the storage portion 20.

The internal cover 35 may be integrally formed by being connected to the external cover 31 through an elastic joint 50. In addition, an inner surface of the internal cover 35 may be in surface contact with the portable terminal to elastically support the portable terminal.

The internal cover 35 is provided with a pair of side portions 36 protruding toward the external cover 31 on edges of the internal cover, corresponding to the side portions 32 of the external cover 31. Therefore, the side portions 36 of the internal cover 35 are also be disposed to be substantially perpendicular to the pivot axis P of the external cover 31.

The side portions 36 of the internal cover 35 may be disposed to overlap the side portions 32 of the external cover 31 inwardly or outwardly of the side portions 32 of the external cover 31.

The insertion space 40 into which the portable terminal 1 is inserted may be formed between the internal cover 35 and the external cover 31. However, a configuration thereof is not limited thereto.

The configuration of embodiments may be variously modified, for example, the internal cover 35 and the external cover 31 may be disposed to closely contact each other and may only be spaced apart from each other adjacently to the entrance of the insertion space 40.

The internal cover 35 and the external cover 31 may be spaced apart from each other by an interval corresponding to a width of respective side portions of 32 and 36, a protruding distance thereof. Thus, the insertion space 40 between the internal cover 35 and the external cover 31 may be defined by a width of the side portions 32 of the external cover 31 or a width of the side portions 36 of the internal cover 35.

The internal cover 35 may have at least one cut-out portion 38 formed adjacently to the entrance of the insertion space 40.

The cut-out portion 38 may be formed by removing a portion of the internal cover 35 on a central axis thereof in a widthwise direction. The cut-out portion 38 may be provided to allow a user to easily withdraw a portable terminal inserted into the insertion space 40.

In a case in which the cut-out portion 38 is omitted, a majority of a body portion of the portable terminal 1 may be inserted into the insertion space 40. Therefore, in this case, a user may experience difficulty in withdrawing the portable terminal inserted into the insertion space 40.

However, in the case that the cut-out portion 38 is formed as in the embodiment, since a portion of the portable terminal is exposed through the cut-out portion 38, the portable terminal 1 may be easily withdrawn by a user grasping the exposed portion thereof.

In addition, the insertion space 40 may have a relatively increased width in a position thereof adjacent to the entrance of the insertion space 40, so that a user may easily insert or withdraw the portable terminal 1.

To this end, the internal cover 35 may be formed to have a form allowing the width of the insertion space 40 to be increased in a position of the entrance of the insertion space 40. For example, as illustrated in FIG. 3, the internal cover 35 is formed in such a manner that an upper end thereof, forming the entrance of the insertion space 40, is bent away from the external cover 31.

The elastic joint 50 elastically connects the internal cover 35 to the external cover 31 in such a manner that the internal cover 35 and the external cover 31 are in close contact with each other. As in a case in which the portable terminal is inserted, when external force is applied, the internal cover 35 may be spaced apart from the external cover 31. Since in this process, the elastic joint 50 is elastically deformed, an amount of force for maintaining a state of close contact between the internal cover 35 and the external cover 31 may be continuously exerted.

Thus, the portable terminal disposed between the internal cover 35 and the external cover 31 is firmly pressed to interior surfaces of the insertion space 40 by elastic force of the elastic joint 50.

As a member of the elastic joint 50, various members offering elastic force, such as a spring or a rubber member, may be used.

For example, as a type of the elastic joint 50, a coil spring or a plate spring may be used. In more detail, the elastic joint 50 may be formed by connecting two ends of a coil spring to the internal cover 35 and the external cover 31, respectively, but is not limited thereto. The elastic joint 50 may be variously modified. For example, a plate spring may be disposed on the external cover 31, and a protrusion elastically deforming the plate spring may be disposed on the internal cover 35. In this case, when the internal cover 35 is spaced apart from the external cover 31, the protrusion may elastically deform the plate spring. As in such a configuration, the elastic joint 50 may be variously configured.

The elastic joint 50 according to the embodiment may be configured as a pair thereof to be disposed adjacently to the side portions 32 and 36, respectively, but are not limited thereto. In order to offer a relatively great amount of elastic force or a uniform amount of elastic force, more elastic joint members 50 may also be disposed in a plurality of positions.

The cover 30 according to the embodiment may be provided with a magnetic portion 33 disposed between the internal cover 35 and the portable terminal. As a material of the magnetic portion 33, various magnetic substance materials such as ferrite, by which a magnetic path may be easily formed, may be used. Additionally, the magnetic portion 33 may be formed as a thin sheet to be attached to the inner surface of the internal cover 35.

When the portable terminal 1 is inserted into the insertion space, the magnetic portion 33 acts to significantly reduce magnetic flux leakage by providing a magnetic circuit while the magnetic portion 33 is in surface contact with the portable terminal 1.

Furthermore, although not illustrated, the magnetic portion 33 may be variously transformed. For example, a magnetic portion (not illustrated) may be attached to the side portions 36 of the internal cover 35 or the side portions 32 of the external cover 31, or the side portions 32 and 36 may be formed of a magnetic substance.

In addition, in the case of the wireless charging device 100 according to the embodiment, a buffer member (not illustrated) may be disposed on an inner surface of the external cover 31 or the internal cover 35.

The buffer member may be attached to the inner surface of the external cover 31 or the internal cover 35 to prevent the portable terminal from slipping. Furthermore, the buffer member may prevent the portable terminal from being scratched, as the portable terminal directly contacts the external cover 31 or the internal cover 35.

Thus, the buffer member may be attached in a form of a pad, a block, or a band including a rubber material or a sponge material, but is not limited thereto.

Further, a surface of the magnetic portion 33 may be formed of a rubber material or a sponge material so that the magnetic portion 33 may also function as a buffer member.

As set forth above, according to embodiments, since in the case of the wireless charging device for a vehicle, a battery of a portable terminal may be charged while the portable terminal is stored in a cup holder cover provided in a majority of vehicles, an interior space of a vehicle may be efficiently used. Additionally, since the portable terminal may be safely fixed so as not to be shaken or disturbed from an established electromagnetic coupling, charging efficiency is increased.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless charging device for a vehicle, comprising:
an external cover configured to be pivotally connected to an interior of a vehicle and including a wireless charger within the external cover;
an internal cover movably connected to an inner surface of the external cover and configured to elastically support a power receiving device receiving electrical power transmitted by the wireless charging module; and
at least one elastic joint elastically connecting the internal cover to the external cover.

2. The wireless charging device for a vehicle of claim 1, wherein the elastic joint is formed of a coil spring, one end of the elastic joint is connected to the external cover, and the other end of the elastic joint is connected to the internal cover.

3. The wireless charging device for a vehicle of claim 1, wherein the internal cover is provided with at least one cut-out portion formed adjacently to an entrance into which the power receiving device is inserted.

4. The wireless charging device for a vehicle of claim 1, wherein the external cover comprises a pair of side portions protruding from edges of a surface of the external cover toward the internal cover.

5. The wireless charging device for a vehicle of claim 4, wherein the side portions of the external cover are disposed perpendicular to a pivot axis of the external cover.

6. The wireless charging device for a vehicle of claim 4, wherein the internal cover comprises a pair of side portions protruding toward the external cover.

7. The wireless charging device for a vehicle of claim 1, wherein the internal cover is in surface contact with the power receiving device and is configured to elastically support the power receiving device.

8. The wireless charging device for a vehicle of claim 1, further comprising a magnetic portion attached to an inner surface of the internal cover.

9. The wireless charging device for a vehicle of claim 8, wherein the magnetic portion is configured of a ferrite sheet.

10. The wireless charging device for a vehicle of claim 1, wherein the wireless charger comprises a coil portion including at least one coil, and a circuit portion electrically connected to the coil portion to control electrical power applied to the coil portion.

11. The wireless charging device for a vehicle of claim 10, wherein the coil portion and the circuit portion are provided in a form of a planar plate, and embedded in the external cover in an overlapping state.

12. A wireless charging device for a vehicle comprising:
an external cover configured to open or close an entrance of a storage space;
an internal cover elastically connected to the external cover and configured to elastically support a power receiving device to maintain the power receiving device in surface contact with a surface of the external cover; and
a wireless charger disposed within the external cover and configured to wirelessly transmit electrical power to the power receiving device.
